(19) United States
(12) Patent Application Publication
(10) Pub. No.: US 2011/0145245 A1
(43) Pub. Date: Jun. 16, 2011

(54) ELECTRONIC DEVICE AND METHOD FOR PROVIDING INFORMATION USING THE SAME

(76) Inventor: Seheon CHOI, Seoul (KR)

(21) Appl. No.: 12/965,644

(22) Filed: Dec. 10, 2010

(30) Foreign Application Priority Data
Dec. 11, 2009 (KR) 10-2009-0123344

(51) Int. Cl. G06F 17/30

(52) U.S. Cl. 707/737; 707/E17.005

(57) ABSTRACT

An electronic device and method for providing information using the same are provided. According to an embodiment, the electronic device acquires relationships between or among people or assigns relationships between or among people and manages data regarding the people based on the relationships.

### CROSS REFERENCE TO RELATED APPLICATIONS

The present application is related to, and claims to priority to, KR Patent Application No. 10-2009-0123344, filed on Dec. 11, 2009, the entire contents of which are incorporated herein by reference.

### BACKGROUND OF THE INVENTION

1. Field of the Invention

The present invention relates to an electronic device and, more particularly, to an electronic device that acquires relationships between or among people or assign relationships between or among people and manages data regarding the people based on the relationships, and a method for providing information using the same.

2. Description of the Related Art

As functions of electronic devices are diversified and a memory capacity increases, types and capacity of information to be managed by electronic devices are increasing.

Thus, the development of various techniques for acquiring new information by analyzing and processing information that can be managed by electronic devices and providing the acquired information to users is on demand.

### SUMMARY OF THE INVENTION

Therefore, an object of the present invention is to provide an electronic device capable of acquiring relationships between or among people or assigning relationships between or among people to provide new information to a user, and a method for providing information using the same.

Another object of the present invention is to provide an electronic device capable of managing data related to people on the basis of the relationships between or among people, and a method for providing information using the same.

Still another object of the present invention is to provide an electronic device capable of assigning levels to (or, grading, classifying, or ranking) the relationships between or among people, providing new information to a user on the basis of the level-assigned relationships, and managing data related to the people, and a method for providing information using the same.

To achieve the above objects, there is provided an electronic device including: a memory configured to store a database managing information regarding a plurality of people; and a controller configured to assign relationships between or among the plurality of people according to at least one first reference and manage data related to the plurality of people according to the assigned relationships.

To achieve the above objects, there is also provided a method for providing information of an electronic device including database managing information regarding a plurality of people, including: assigning relationships between or among the plurality of people according to at least one first reference; and managing data related to the plurality of people according to the assigned relationships.

The electronic device and method for providing information using the same according to exemplary embodiments of the present invention have the following advantages.

Because relationships between or among people are acquired or assigned, new information different from that of the related art can be provided to users.

Also, data related to people can be managed on the basis of the relationships between or among people.

In addition, because the relationships between or among people can be assigned levels, new information can be provided to users on the basis of the level-assigned relationships and data related to the people can be managed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic block diagram of an electronic device according to an exemplary embodiment of the present invention.

FIG. 2 is a table of information of people configured to explain exemplary embodiments.

FIG. 3 is a flow chart illustrating the process of a method for providing information of an electronic device according to an exemplary embodiment of the present invention.

FIGS. 4 to 11 are views for explaining the method for providing information of an electronic device according to an exemplary embodiment of the present invention.

FIG. 12 is a flow chart illustrating a first exemplary embodiment of the process of providing data.

FIGS. 13 to 15 are views for explaining an actually implemented example of providing data according to the first exemplary embodiment.

FIG. 16 is a flow chart illustrating a second exemplary embodiment of the process of providing data.

FIGS. 17 to 21 are views for explaining an actually implemented example of providing data according to the second exemplary embodiment.

FIG. 22 is a flow chart illustrating a third exemplary embodiment of process of providing data.

FIG. 23 is a view for explaining an actually implemented example of providing data according to the second exemplary embodiment.

### DETAILED DESCRIPTION OF THE INVENTION

The foregoing and other objects, features, aspects and advantages of the present invention will become more apparent from the following detailed description of the present invention when taken in conjunction with the accompanying drawings. Exemplary embodiments of the present invention will now be described in detail with reference to the accompanying drawings. The same reference numerals will be used throughout to designate the same or like components. In describing the present invention, if a detailed explanation for a related known function or construction is considered to unnecessarily divert the gist of the present invention, such explanation will be omitted but would be understood by those skilled in the art.

An electronic device according to exemplary embodiments of the present invention will now be described with reference to the accompanying drawings. In the following description, usage of suffixes such as ‘module’, ‘part’ or ‘unit’ used for referring to elements is given merely to facilitate explanation of the present invention, without having any significant meaning by itself.

The electronic device described in the present invention may include mobile phones, smart phones, computers, notebook computers, digital broadcasting terminals, PDAs (Personal Digital Assistants), PMPs (Portable Multimedia Player), navigation devices, and the like.

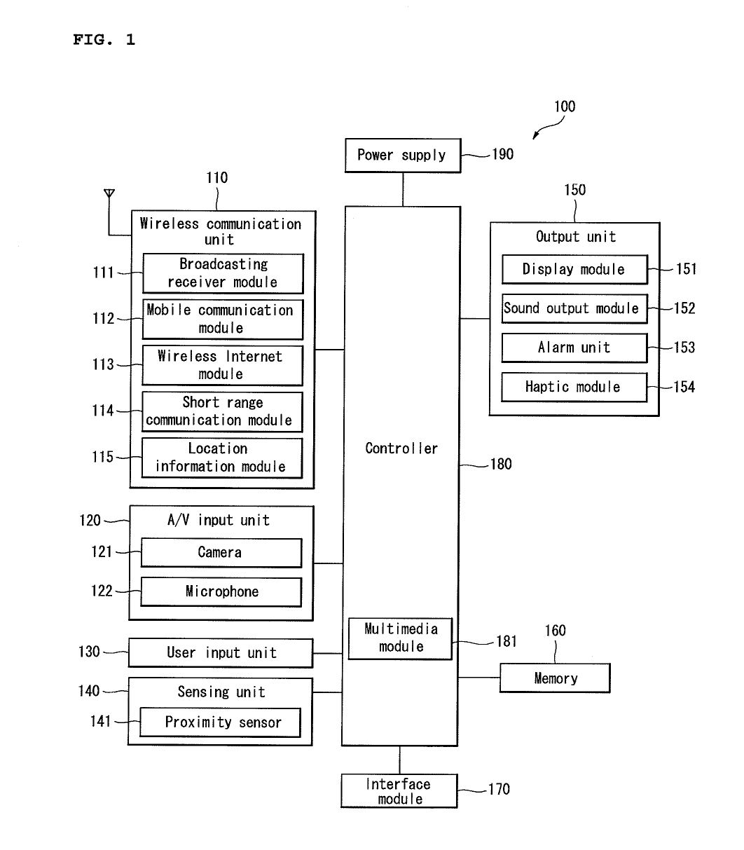

FIG. 1 is a block diagram of an electronic device according to an embodiment of the present invention.

The electronic device 100 may include a wireless communication unit 110, an A/V (Audio/Video) input unit 120, a user input unit 130, a sensing unit 140, an output unit 150, a memory 160, an interface unit 170, a controller 180, and a power supply unit 190, etc. FIG. 1 shows the electronic device as having various components, but it should be understood that implementing all of the illustrated components is not a requirement. Greater or fewer components may alternatively be implemented.

The elements of the electronic device will be described in detail as follows.

The wireless communication unit 110 typically includes one or more components allowing radio communication between the electronic device 100 and a wireless communication system or a network in which the electronic device is located. For example, the wireless communication unit may include at least one of a broadcast receiving module 111, a mobile communication module 112, a wireless Internet module 113, a short-range communication module 114, and a location information module 115.

The broadcast receiving module 111 receives broadcast signals and/or broadcast associated information from an external broadcast management server via a broadcast channel.

The broadcast channel may include a satellite channel and/or a terrestrial channel. The broadcast management server may be a server that generates and transmits a broadcast signal and/or broadcast associated information or a server that receives a previously generated broadcast signal and/or broadcast associated information and transmits the same to a terminal. The broadcast signal may include a TV broadcast signal, a radio broadcast signal, a data broadcast signal, and the like. Also, the broadcast signal may further include a broadcast signal combined with a TV or radio broadcast signal.

The broadcast associated information may refer to information associated with a broadcast channel, a broadcast program or a broadcast service provider. The broadcast associated information may also be provided via a mobile communication network and, in this case, the broadcast associated information may be received by the mobile communication module 112.

The broadcast signal may exist in various forms. For example, it may exist in the form of an electronic program guide (EPG) of digital multimedia broadcasting (DMB), electronic service guide (ESG) of digital video broadcast-handheld (DVB-H), and the like.

The broadcast receiving module 111 may be configured to receive signals broadcast by using various types of broadcast systems. In particular, the broadcast receiving module 111 may receive a digital broadcast by using a digital broadcast system such as multimedia broadcasting-terrestrial (DMB-T), digital multimedia broadcasting-satellite (DMB-S), digital video broadcast-handheld (DVB-H), the data broadcasting system known as media forward link only (MediaFLO®), integrated services digital broadcast-terrestrial (ISDB-T), etc. Of course, the broadcast receiving module 111 may be configured to be suitable for every broadcast system that provides a broadcast signal as well as the above-mentioned digital broadcast systems.

Broadcast signals and/or broadcast-associated information received via the broadcast receiving module 111 may be stored in the memory 160.

The mobile communication module 112 transmits and/or receives radio signals to and/or from at least one of a base station, an external terminal and a server. Such radio signals may include a voice call signal, a video call signal or various types of data according to text and/or multimedia message transmission and/or reception.

The wireless Internet module 113 supports wireless Internet access for the electronic device. This module may be internally or externally coupled to the terminal. The wireless Internet access technique implemented may include a WLAN (Wireless LAN) (Wi-Fi), Wibro (Wireless broadband), Wimax (World Interoperability for Microwave Access), HSDPA (High Speed Downlink Packet Access), or the like.

The short-range communication module 114 is a module for supporting short range communications. Some examples of short-range communication technology include Bluetooth™, Radio Frequency IDentification (RFID), Infrared Data Association (IrDA), Ultra-WideBand (UWB), ZigBee™, and the like.

The location information module 115 is a module for checking or acquiring a location (or position) of the electronic device.

The location information module 115 is a module for checking or acquiring a location of the mobile terminal. The location information module 115 may acquire location information by using a global navigation satellite system (GNSS). Here, the GNSS is the standard generic term for satellite navigation systems revolving around the earth and allowing certain types of radio navigation receivers to transmit reference signals determining their location on or in the vicinity of the surface of the earth. The GNSS may include the United States' global positioning system (GPS), the European Union's Galileo positioning system, the Russian global orbiting navigational satellite system (GLONASS), COMPASS, a compass navigation system, by the People's Republic of China, and the quasi-zenith satellite system (QZSS) by Japan.

A typical example of GNSS is a GPS (Global Positioning System) module. The GPS module 115 may calculate information regarding the distance from one point (entity) to three or more satellites and information regarding time at which the distance information was measured, and applies trigonometry to the calculated distance, thereby calculating three-dimensional location information according to latitude, longitude, and altitude with respect to the one point (entity). In addition, a method of acquiring location and time information by using three satellites and correcting an error of the calculated location and time information by using another one satellite may be also used. The GPS module 115 may continuously calculate the current location in real time and also calculate speed information by using the continuously calculated current location.

With reference to FIG. 1, the A/V input unit 120 is configured to receive an audio or video signal. The A/V input unit 120 may include a camera 121 and a microphone 122. The camera 121 processes image data of still pictures or video obtained by an image capture device in a video capturing mode or an image capturing mode. The processed image frames may be displayed on a display unit 151.

The image frames processed by the camera 121 may be stored in the memory 160 or transmitted via the wireless communication unit 110. Two or more cameras 121 may be provided according to the configuration of the electronic device.

The microphone 122 may receive sounds via a microphone in a phone call mode, a recording mode, a voice recognition mode, and the like, and can process such sounds into audio data. The processed audio data may be converted for output into a format transmittable to a mobile communication base station via the mobile communication module 112 in case of the phone call mode. The microphone 122 may implement various types of noise canceling (or suppression) algorithms to cancel (or suppress) noise or interference generated in the course of receiving and transmitting audio signals.

The user input unit 130 (or other user input device) may generate input data from commands entered by a user to control various operations of the electronic device. The user input unit 130 may include a keypad, a dome switch, a touch pad (e.g., a touch sensitive member that detects changes in resistance, pressure, capacitance, etc. due to being contacted), a jog wheel, a jog switch, and the like.

The sensing unit 140 detects a current status of the electronic device 100 such as an opened or closed state of the electronic device 100, a location of the electronic device 100, the presence or absence of user contact with the electronic device 100, the orientation of the electronic device 100, an acceleration or deceleration movement and direction of the electronic device 100, etc., and generates commands or signals for controlling the operation of the electronic device 100. For example, when the electronic device 100 is implemented as a slide type mobile phone, the sensing unit 140 may sense whether the slide phone is opened or closed. In addition, the sensing unit 140 can detect whether or not the power supply unit 190 supplies power or whether or not the interface unit 170 is coupled with an external device. The sensing unit 140 may include a proximity sensor 141.

The output unit 150 is configured to provide outputs in a visual, audible, and/or tactile manner. The output unit 150 may include the display unit 151, an audio output module 152, an alarm unit 153, a haptic module 154, and the like.

The display unit 151 may display information processed in the electronic device 100. For example, when the electronic device 100 is in a phone call mode, the display unit 151 may display a User Interface (UI) or a Graphic User Interface (GUI) associated with a call or other communication (such as text messaging, multimedia file downloading, etc.).

The display unit 151 may include at least one of a Liquid Crystal Display (LCD), a Thin Film Transistor-LCD (TFT-LCD), an Organic Light Emitting Diode (OLED) display, a flexible display, a three-dimensional (3D) display, or the like.

Some of them may be configured to be transparent or light-transmissive to allow for viewing of the exterior, which may be called transparent displays. A typical transparent display may be, for example, a TOLED (Transparent Organic Light Emitting Diode) display, or the like. A rear structure of the display unit 151 may be also light-transmissive. Through such configuration, the user can view an object positioned at the rear side of the terminal body through the region occupied by the display unit 151 of the terminal body.

The electronic device 100 may include two or more display units according to its particular desired embodiment. For example, a plurality of display units may be separately or integrally disposed on one surface of the electronic device, or may be separately disposed on mutually different surfaces.

Meanwhile, when the display unit 151 and a sensor (referred to as a ‘touch sensor’, hereinafter) for detecting a touch operation are overlaid in a layered manner to form a touch screen, the display unit 151 may function as both an input device and an output device. The touch sensor may have a form of a touch film, a touch sheet, a touch pad, and the like.

The touch sensor may be configured to convert pressure applied to a particular portion of the display unit 151 or a change in the capacitance or the like generated at a particular portion of the display unit 151 into an electrical input signal. The touch sensor may be configured to detect the pressure when a touch is applied, as well as the touched position and area.

When there is a touch input with respect to the touch sensor, a corresponding signal (signals) are transmitted to a touch controller. The touch controller processes the signals and transmits corresponding data to the controller 180. Accordingly, the controller 180 may recognize which portion of the display unit 151 has been touched.

With reference to FIG. 1, a proximity sensor 141 may be disposed within or near the touch screen. The proximity sensor 141 is a sensor for detecting the presence or absence of an object relative to a certain detection surface or an object that exists nearby by using the force of electromagnetism or infrared rays without a physical contact. Thus, the proximity sensor 141 has a considerably longer life span compared with a contact type sensor, and it can be utilized for various purposes.

Examples of the proximity sensor 141 may include a transmission type photoelectric sensor, a direct reflection type photoelectric sensor, a mirror-reflection type photo sensor, an RF oscillation type proximity sensor, a capacitance type proximity sensor, a magnetic proximity sensor, an infrared proximity sensor, and the like.

In case where the touch screen is the capacitance type, proximity of the pointer is detected by a change in electric field according to the proximity of the pointer. In this case, the touch screen (touch sensor) may be classified as a proximity sensor 141.

In the following description, for the sake of brevity, recognition of the pointer positioned to be close to the touch screen will be called a ‘proximity touch’, while recognition of actual contacting of the pointer on the touch screen will be called a ‘contact touch’. In this case, when the pointer is in the state of the proximity touch, it means that the pointer is positioned to correspond vertically to the touch screen.

By employing the proximity sensor, a proximity touch and a proximity touch pattern (e.g., a proximity touch distance, a proximity touch speed, a proximity touch time, a proximity touch position, a proximity touch movement state, or the like) can be detected, and information corresponding to the detected proximity touch operation and the proximity touch pattern can be outputted to the touch screen.

The audio output module 152 may convert and output as sound audio data received from the wireless communication unit 110 or stored in the memory 160 in a call signal reception mode, a call mode, a record mode, a voice recognition mode, a broadcast reception mode, and the like. Also, the audio output module 152 may provide audible outputs related to a particular function performed by the electronic device 100 (e.g., a call signal reception sound, a message reception sound, etc.). The audio output module 152 may include a speaker, a buzzer, or the like. In addition, the audio output module 152 may output a sound through an earphone jack.

The alarm unit 153 may provide outputs to inform about the occurrence of an event of the electronic device 100. Typical events may include call reception, message reception, key signal inputs, a touch input etc. In addition to audio or video outputs, the alarm unit 153 may provide outputs in a different manner to inform about the occurrence of an event. For example, the alarm unit 153 may provide an output in the form of vibrations. The video signal or the audio signal may be also outputted through the display unit 151 or the audio output module 152.

A haptic module 154 generates various tactile effects the user may feel. A typical example of the tactile effects generated by the haptic module 154 is vibration. The strength and pattern of the haptic module 154 can be controlled. For example, different vibrations may be combined to be outputted or sequentially outputted.

Besides vibration, the haptic module 154 may generate various other tactile effects such as an effect by stimulation such as a pin arrangement vertically moving with respect to a contact skin, a spray force or suction force of air through a jet orifice or a suction opening, a contact on the skin, a contact of an electrode, electrostatic force, etc., an effect by reproducing the sense of cold and warmth using an element that can absorb or generate heat.

The haptic module 154 may be implemented to allow the user to feel a tactile effect through a muscle sensation such as fingers or arm of the user, as well as transferring the tactile effect through a direct contact. Two or more haptic modules 154 may be provided according to the configuration of the electronic device 100.

The memory 160 may store software programs used for the processing and controlling operations performed by the controller 180, or may temporarily store data (e.g., a phonebook, messages, still images, video, etc.) that are inputted or outputted. In addition, the memory 160 may store data regarding various patterns of vibrations and audio signals outputted when a touch is inputted to the touch screen.

The memory 160 may include at least one type of storage medium including a flash memory, a hard disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the electronic device 100 may be operated in relation to a web storage device that performs the storage function of the memory 160 over the Internet.

The interface unit 170 serves as an interface with every external device connected with the electronic device 100. For example, the external devices may transmit data to an external device, receives and transmits power to each element of the electronic device 100, or transmits internal data of the electronic device 100 to an external device. For example, the interface unit 170 may include wired or wireless headset ports, external power supply ports, wired or wireless data ports, memory card ports, ports for connecting a device having an identification module, audio input/output (I/O) ports, video PO ports, earphone ports, or the like.

The identification module may be a chip that stores various information for authenticating the authority of using the electronic device 100 and may include a user identity module (UIM), a subscriber identity module (SIM) a universal subscriber identity module (USIM), and the like. In addition, the device having the identification module (referred to as ‘identifying device’, hereinafter) may take the form of a smart card. Accordingly, the identifying device may be connected with the electronic device 100 via a port.

When the electronic device 100 is connected with an external cradle, the interface unit 170 may serve as a passage to allow power from the cradle to be supplied therethrough to the electronic device 100 or may serve as a passage to allow various command signals inputted by the user from the cradle to be transferred to the electronic device therethrough. Various command signals or power inputted from the cradle may operate as signals for recognizing that the electronic device is properly mounted on the cradle.

The controller 180 typically controls the general operations of the electronic device. For example, the controller 180 performs controlling and processing associated with voice calls, data communications, video calls, and the like. The controller 180 may include a multimedia module 181 for reproducing multimedia data. The multimedia module 181 may be configured within the controller 180 or may be configured to be separated from the controller 180.

The controller 180 may perform a pattern recognition processing to recognize a handwriting input or a picture drawing input performed on the touch screen as characters or images, respectively.

The power supply unit 190 receives external power or internal power and supplies appropriate power required for operating respective elements and components under the control of the controller 180.

Various embodiments described herein may be implemented in a computer-readable or its similar medium using, for example, software, hardware, or any combination thereof.

For hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, electronic units designed to perform the functions described herein. In some cases, such embodiments may be implemented by the controller 180 itself.

For software implementation, the embodiments such as procedures or functions described herein may be implemented by separate software modules. Each software module may perform one or more functions or operations described herein. Software codes can be implemented by a software application written in any suitable programming language. The software codes may be stored in the memory 160 and executed by the controller 180.

Exemplary embodiments of the present invention will now be described. The exemplary embodiments disclosed in this document may be implemented by the electronic device 100 as described above with reference to FIG. 1.

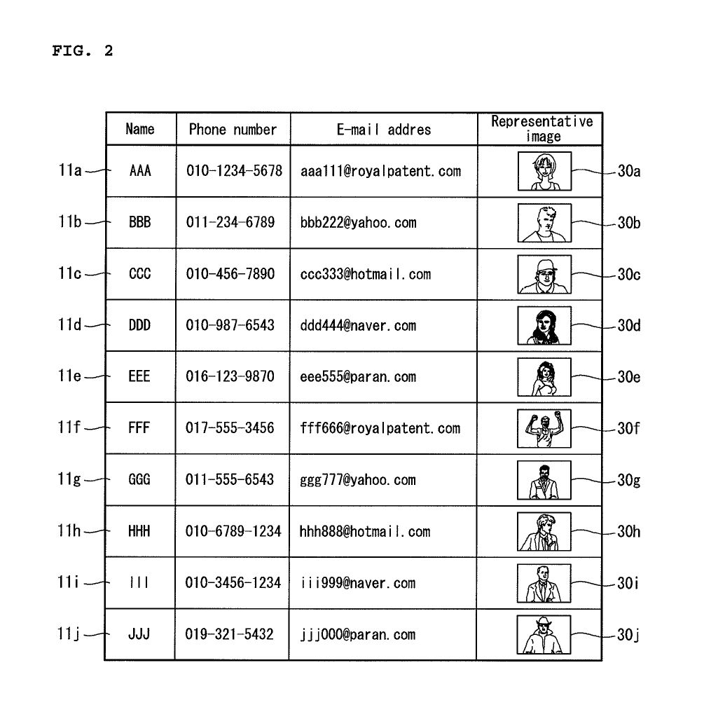

For convenience of description, first to tenth people are configured. FIG. 2 illustrates information regarding the configured people to explain the exemplary embodiments. As shown in FIG. 2, it is assumed that the first to tenth people's name are “AAA” (11a), “BBB” (11b), “CCC” (11c), “DDD” (11d), “EEE” (11e), “FFF” (11f), “GGG” (11g), “HHH” (11h), “III” (11i), and “JJJ” (11j).

At least one of a phone number, an e-mail address, and a representative image may be matched to each of the first to tenth people 11a, 11b, 11c, 11d, 11e, 11f, 11g, 11h, 11i, and 11j.

FIG. 2 shows representative images 30a, 30b, 30c, 30d, 30e, 30f, 30g, 30h, 30i, and 30j matched to each of the first to tenth people 11a, 11b, 11c, 11d, 11e, 11f, 11g, 11h, 11i, and 11j.

All of the phone number, the e-mail address, and the representative image may not need to be matched to each of the first to tenth people 11a, 11b, 11c, 11d, 11e, 11f, 11g, 11h, 11i, and 11j.

Information other than the name of a specific person among the first to tenth people 11a, 11b, 11c, 11d, 11e, 11f, 11g, 11h, 11i, and 11j may not be stored.

The memory 160 may store a database managing information regarding the first to tenth people. One or more databases may be included in the memory 160.

One database may not necessarily manage the entire information regarding the first to tenth people.

For example, the first database may manage information regarding the first to fourth people, and the second database may manage information regarding the fifth to tenth people.

The database may be, for example, a phone book, an address list, and the like.

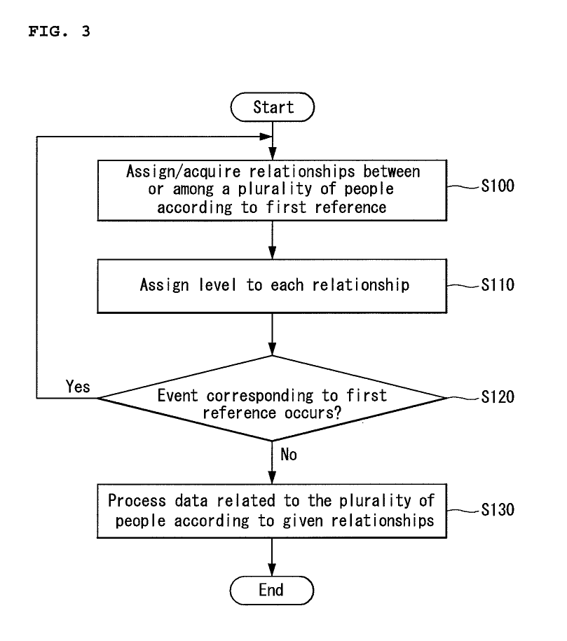

FIG. 3 is a flow chart illustrating the process of a method for providing information of an electronic device according to an exemplary embodiment of the present invention. FIGS. 4 to 11 are views for explaining the method for providing information of an electronic device according to an exemplary embodiment of the present invention.

The method for providing information of an electronic device according to an exemplary embodiment of the present invention and the operation of the electronic device 100 for implementing the method will now be described in detail with reference to the accompanying drawings.

With reference to FIG. 3, the controller 180 assigns relationships between or among a plurality of people according to a first reference (S100).

The first reference, which is to acquire relationships existing between or among the plurality of people, may vary.

In an exemplary embodiment, the controller 180 may assigns the relationships between or among at least two or more people managed as the same group in the electronic device 100.

There may be various examples that at least two or more people are managed as the same group in the electronic device 100.

A phone book may provide at least one group according to a user setting as a default. Each of at least one group may include information regarding at least one person.

The information regarding at least one person may include at least one of a name, a phone number, an address, an e-mail address and a representative image.

FIG. 4 shows an example of a phone book providing a plurality of groups. With reference to FIG. 4, for example, the phone book provides four groups 10 of “friend” (10a), “family” (10b), “company” (10c), and “client” (10d).

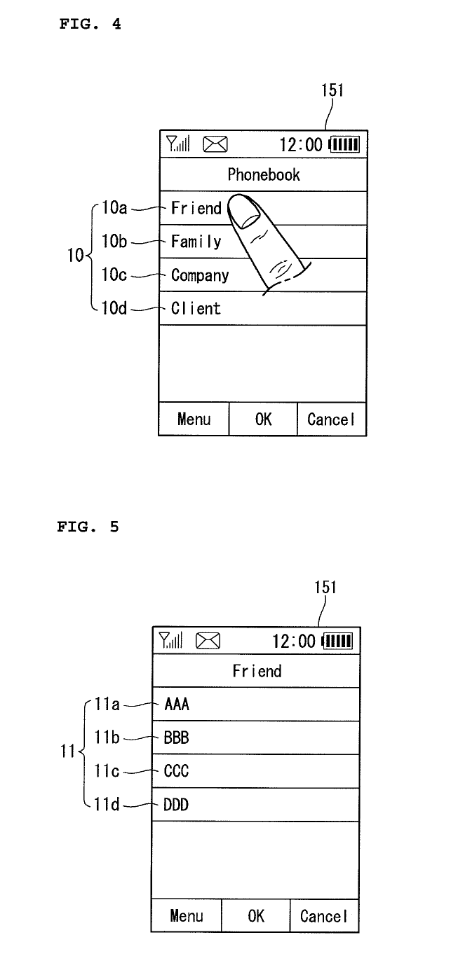

FIG. 5 shows an example of a screen image when the group “friend” is selected. The group “friend” illustrated in FIG. 5 includes four people: a first person “AAA” (11a), a second person “BBB” (11b), a third person “CCC” (11c), and a fourth person “DDD” (11d).

The controller 180 may assign the relationships between or among at least two or more people belonging to the same group of the phone book.

FIG. 6 is a view for explaining the relationships assigned among the people illustrated in FIG. 5.

With reference to FIGS. 5 and 6, for example, the controller 180 may assign relationships 20, 21, 22, 23, 24, and 25 among the first person 11a, second person 11b, third person 11c, and fourth person 11d.

The controller 180 may recognize that at least two or more people mentioned jointly in specific data stored in the memory 180 are managed as the same group, and assign the relationships among the at least two or more people mentioned jointly in the specific data.

For example, the memory 160 may store a specific schedule managed by an application such as a scheduler.

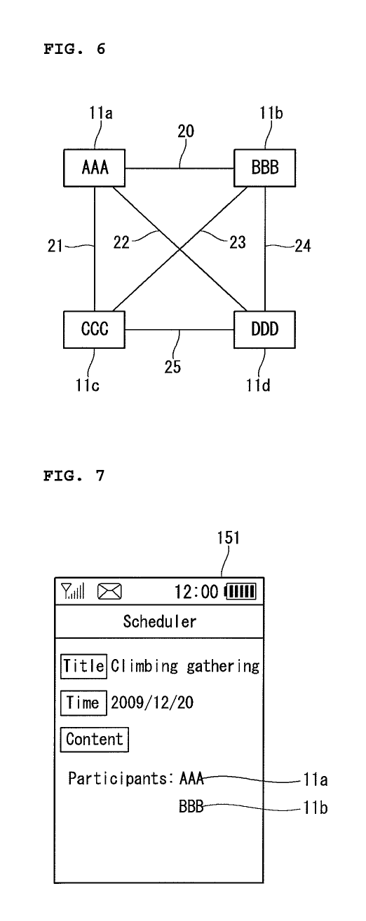

FIG. 7 illustrates an example of schedule data. In the schedule data illustrated in FIG. 7, the first person 11a and the second person 11b are included as participants.

Thus, the controller 180 may assign relationship between the first person 11a and the second person 11b.

Also, for example, the memory 160 may store various data such as a memo or the like, besides the schedule. And, the controller 180 may assign relationship between the at least two or more people mentioned jointly in the data, as illustrated in FIG. 7.

As will be described, in managing data regarding people assigned the relationship, the assigned relationship may be used.

In another exemplary embodiment, the controller 180 may assign the relationship between or among at least two or more people contained jointly in a message transmitted or received by the electronic device 100, as the first reference.

The controller 180 may transmit or receive various messages such as a short message service (SMS), a multimedia messaging service (MMS), an e-mail, and an instant message (IM) through the wireless communication unit 110.

For example, the controller 180 may assign the relationship between or among at least two or more people corresponding to joint recipients of the message.

For example, the user of the electronic device 100 may transmit a message of the same content to the first person 11a, the second person 11b, and the third person 11c.

In this case, the controller 180 may assign the relationships between or among the first to third people 11a, 11b, and 11c which have been set as joint recipients of the message.

Also, for example, the controller 180 may assign the relationships to between or among at least two or more people who correspond to at least one of a recipient and a sender of the message and a person mentioned in the content of the message.

FIG. 8 shows an example of a received message. In the content of the received message illustrated in FIG. 8 as an SMS received from the second person 11b, the fourth person 11d is mentioned.

The controller 180 may recognize that the second person 11b and the fourth person 11d are related to each other and assign the relationship between the second person 11b and the fourth person 11d.

Also, for example, when the user of the electronic device 100 refers to the fifth person 11d in an e-mail when sending the e-mail to the third person 11c, the controller 180 may assign the relationship between the third person 11c and the fifth person 11d.

Meanwhile, the controller 180 may analyze data included in the message and regard information corresponding to a specific person as the specific person.

For example, when the user of the electronic device 100 sends an SMS to the second person 11b, if the content of the SMS includes a phone number of the fourth person 11d, the controller 180 may regard the phone number of the fourth person 11d as the fourth person 11d and assign the relationship between the second person 11b and the fourth person 11d.

The information corresponding to the specific person may include an address, a nickname, an e-mail address, and the like, in addition to the phone number taken as an example as described above.

The method of regarding the information corresponding to the specific person as the specific person himself may be applied in the same manner to a case such as the foregoing schedule, a memo, and the like, as well as to the message.

In still another exemplary embodiment, the controller 180 may receive information related to the relationship between or among the plurality of people from an external terminal (including a server) providing a social network service (SNS), and assign the relationships on the basis of the received information.

The external terminal providing the SNS may be, for example, a Twitter, a Facebook, and the like.

For example, the controller 180 may access the external terminal providing the SNS and receive a list of acquaintances related to a specific person (e.g., the first person 11a) among the people managed in the electronic device 100.

When a person (e.g., the sixth person 11f) managed in the electronic device 100 is included in the received acquaintance list, the controller 180 may assign the relationship between the first person 11a and the sixth person 11f.

It will be appreciated that the method of receiving the acquaintance list from the external terminal providing the SNS by the controller 180 may vary and differ depending on a service policy of the external terminal.

The controller 180 assigns levels to the relationships assigned between or among the plurality of people according to a second reference (S110).

The level assigning to the relationships may include at least one of scoring the relationships and grading the relationships. Namely, the controller 180 may score or grade the relationships.

The degree of level assigning to the relationships may be previously set, or changed or set by the user.

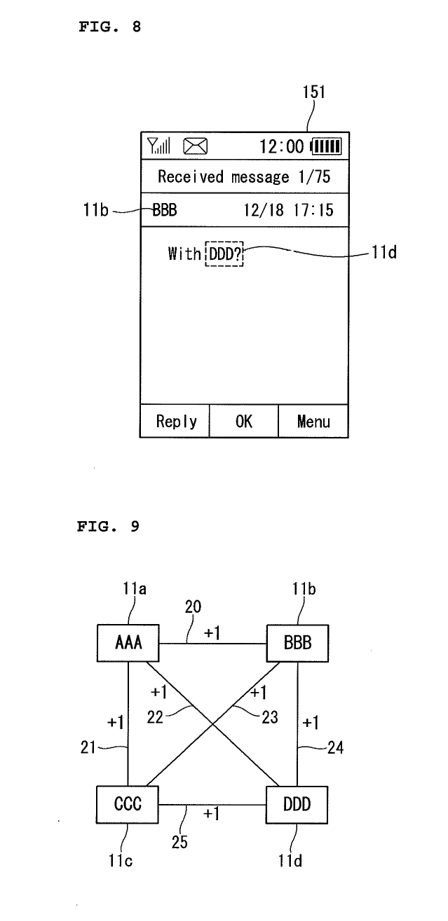

FIG. 9 shows an example of level assigning to the relationships illustrated in FIG. 6. For example, with reference to FIGS. 6 and 9, the controller 180 may assign levels to the relationships assigned between or among the first to fourth people 11a, 11b, 11c, and 11d stored in the same group (e.g., “friend”) of the phone book.

For example, 1 score may be added to the relationship level between the first person 11a and the second person 11b as illustrated in FIG. 9.

The relationship levels may be managed accumulatively according to the occurrence of events corresponding to the first reference.

For example, in a state that the relationship level between the first person 11a and the second person 11b has 1 score as illustrated in FIG. 9, when the user of the electronic device 100 sends a message to the first person 11a and the second person 11b as the joint recipients, the controller 180 adds 1 score to the relationship level between the first person 11a and the second person 11b, so that the relationship level between the first person 11a and the second person 11b totals 2 score.

The accumulative management of the relationship level may include both upward adjusting and downward adjusting.

For example, in a state that the relationship level between the first person 11a and the second person 11b totals 3 scores, when one of the first person 11a and the second person 11b moves to another group of the phone book and stored, the first person 11a and the second person 11b do not belong to the same group of the phone book any longer. Then, the controller 180 subtracts one score from the relationship level, so the relationship level between the first person 11a and the second person 11b totals 2 scores.

As discussed above, the degree of level assigning to the relationships may differently set for each event corresponding to the first reference.

For example, 1 score may be added for the relationship assigned between people belonging to the same group of the phone book. 2 scores may be added for the relationship assigned in relation to a message, like the joint recipient of the message as described above. 0.5 scores may be added for the relationship acquired by using the SNS.

Also, in case of the foregoing message, a level of a higher score may be set to be assigned to a person mentioned in the context compared with the joint recipients or a person referred to.

The relationship having level as described above can provide information regarding an affinity to or relation with a person to the user of the electronic device 100.

As the relationship level between or among specific people is high, the specific people are highly likely to have affinity.

For example, if the first person 11a refers to the second person 11b in sending a mail to the user of the electronic device 100 and the first person 11a and the second person 11b belong to the same group of “friend” of the phone book, then the probability that the first person 11a and the second person 11b are acquaintances is high. Also, the relationship level becomes higher and the affinity between people is likely to high among the people for which an event corresponding to the first reference frequently occurs.

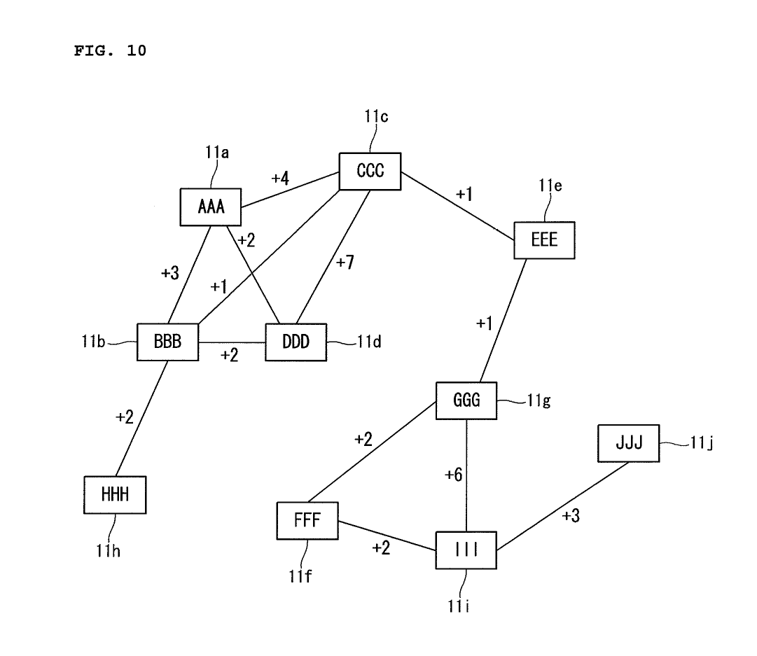

FIG. 10 shows the relationships acquired between people and the level-assigned relationships according to an exemplary embodiment of the present invention.

For example, as shown in FIG. 10, the relationship between the first person 11a and the second person 11b has 3 scores, and the relationship between the first person 11a and the third person 11c has 4 scores, so it can be said that the affinity (or relationship) between the first person 11a and the third person 11c is higher than that between the first person 11a and the second person 11b.

Also, in FIG. 10, it is noted that no relationship is assigned or acquired between the fourth person 11d and the sixth person 11f. Thus, it can be analyzed that the fourth person 11d and the sixth person 11f do not know each other.

Also, in FIG. 10, because the relationship between the third person 11c and the fifth person 11e has 1 score, it can be analyzed that the affinity between the third person 11c and the fifth person 11e is not high or there is not much interaction between the third person 11c and the fifth person 11e.

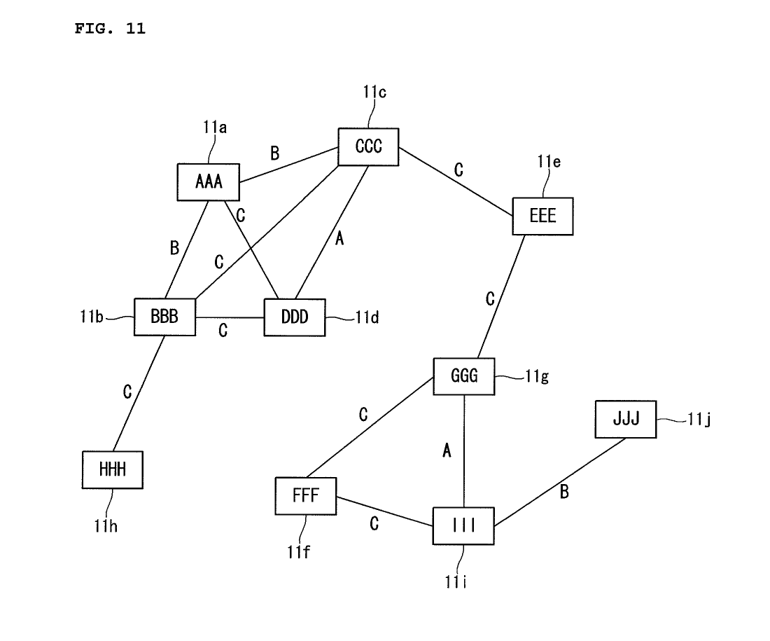

FIG. 11 shows a case in which the relationship levels illustrated in FIG. 10 are indicated as grades. For example, the controller 180 may grade the scored relationships as illustrated in FIG. 10 according to a certain reference.

For example, when the relationship score between two specific people is 5 scores or larger, it may be set to “A”, when the relationship score between two specific people is 3 scores or larger, it may be set to “B”, and when the relationship score between two specific people is lower than 3 scores, it may be set to “C”. As the relationship grade is closer to “A” grade, it can be analyzed that the affinity between the two corresponding people is high.

The information related to the relationships assigned or acquired according to the exemplary embodiments of the present invention and the information related to the relationship level may be managed by the database that manages information regarding the plurality of people or may be managed by an additional database.

The controller 180 determines whether or not an event corresponding to the first reference occurs (S120). The examples of the event corresponding to the first reference are the same as described above. For example, the first reference may be whether or not at least two or more people are managed as the same group in the electronic device 100, whether or not they are jointly included in a message transmitted or received by the electronic device 100, whether or not they acquire the relationship on the basis of information received from an external terminal providing an SNS, and the like.

When an event corresponding to the first reference occurs according to the determination result of step S120, the controller 180 may return to step S100 to update or check the assigned relationship, or assign a new relationship.

When the controller 180 returns to step S100, the controller 180 may perform step S110 again to update the relationship level. As described above, updating of the relationship level may include upgrading or downgrading of the relationship level.

In addition, the controller 180 may manage data related to the plurality of people according to the relationship assigned or acquired or the relationship level assigned by performing steps S100 to S120 (S130).

For example, the controller 180 may provide data related to at least one person assigned the relationship with respect to a person selected from the plurality of people.

The data related to at least one person may include information representing the at least one person. The information representing the person may include at least one of the name, a phone number, an e-mail address, and a representative image.

Also, the data related to at least one person may include a message, a schedule, and phone book information related to the least one person.

Embodiments in which the data related to at least one person assigned the relationship is provided with respect to the selected person will now be described. The following embodiments are based on the assumption of the relationships and relationship levels illustrated in FIG. 10.

In a first embodiment related to provision of data, when receiving a selection signal that a specific person is selected from the database managing a plurality of people, the controller 180 may provide information representing at least one person assigned the relationship according to the present exemplary embodiments to the selected specific person.

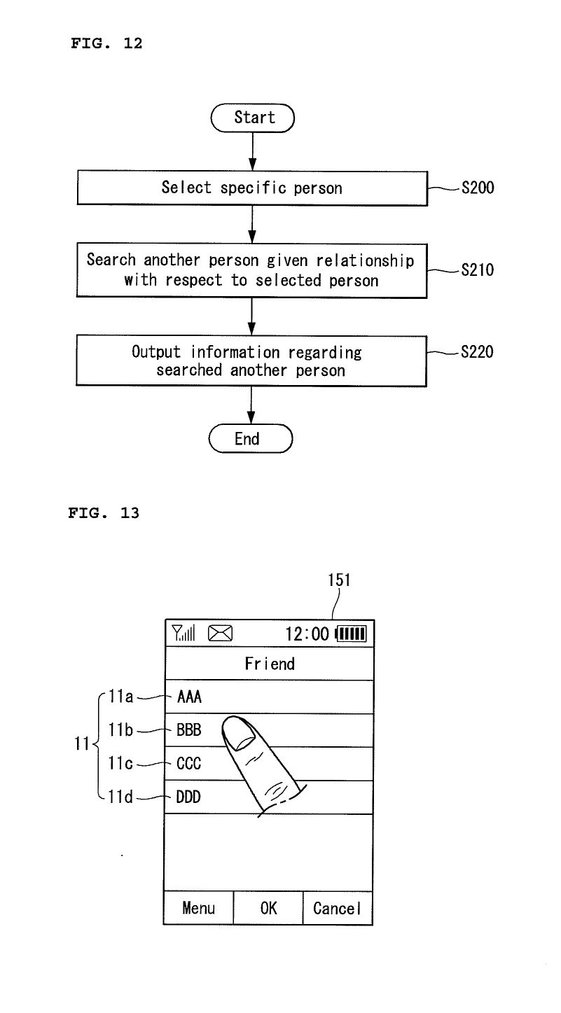

FIG. 12 is a flow chart illustrating a first exemplary embodiment of the process of providing data. FIGS. 13 to 15 are views for explaining an actually implemented example of the first exemplary embodiment of the process of providing data. FIGS. 13 to 15 show a case in which when a specific person is selected from the phone book, information regarding other people related to the selected person is provided. The first exemplary embodiment related to providing the data will now be described with reference to FIGS. 12 to 15.

The controller receives a selection signal with respect to a specific person from the database, such as the phone book, that manages the plurality of people (S200). With reference to FIG. 13, the user may select the second person 11b from the phone book by his finger.

Meanwhile, the controller 180 may additionally provide icons to which the function of providing information regarding other people related to the specific person is matched.

The controller 180 searches for other people assigned relationship with respect to the selected person (S210). The controller 180 may perform step S210 with reference to the database that manages the plurality of people or the additional database.

The controller 180 outputs the information regarding other people searched in step S210 (S220). The types of the information regarding other people and its output methods may vary.

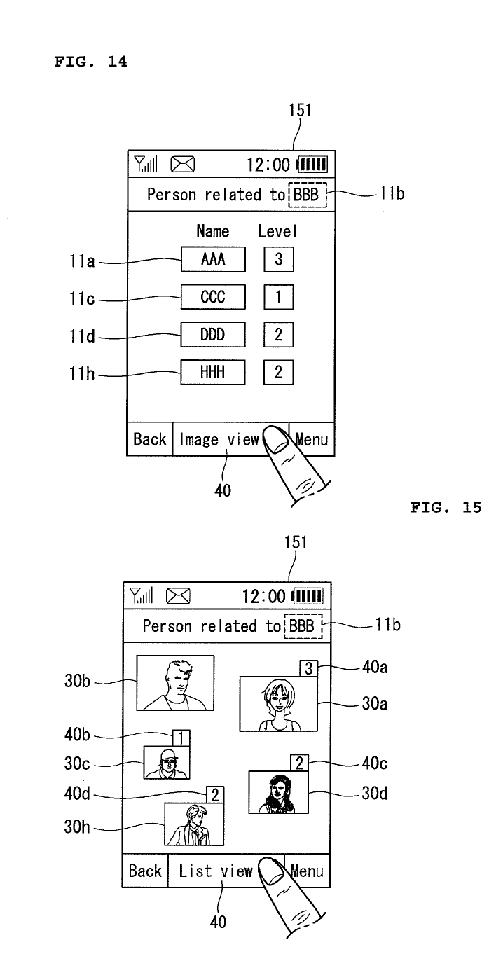

FIGS. 14 and 15 show examples of screen images outputting information other people.

For example, with reference to FIG. 14, the controller 180 may display a name list of the people 11a, 11c, 11d, and 11h related to the selected second person 11b on the display unit 151.

As shown in FIG. 14, the controller 180 may display score levels of the people 11a, 11c, 11d, and 11h assigned the relationship with respect to the second person 11b along with the name list.

For another example, with reference to FIG. 15, the controller 180 may display the representative images 30a, 30b, 30d, and 30h of the people 11a, 11c, 11d, and 11h related to the selected second person 11b on the display unit 151.

As shown in FIG. 15, the controller 180 may also provide score levels 40a, 40b, 40c, and 40d of the people 11a, 11c, 11d, and 11h. Here, the controller 180 may vary the sizes of the representative images according to the score levels.

For example, in FIG. 15, because the relationship level (3 scores) with respect to the first person 11a is the highest, the controller 180 may display the representative image 30a corresponding to the first person 11a such that it is the largest.

Meanwhile, as an example of a screen access method of the user, the controller 180 may provide a soft key 40 for changing the screens in FIGS. 14 and 15. Besides the soft key 40 illustrated in FIGS. 14 and 15, a user interface for changing the screen may be provided in the form of a physical key or according to a voice recognition scheme.

As a second embodiment related to the data provision, when a message is transmitted, the controller 180 may provide information regarding at least one person assigned the relationship according to the present exemplary embodiments, in selecting or adding a recipient of the message.

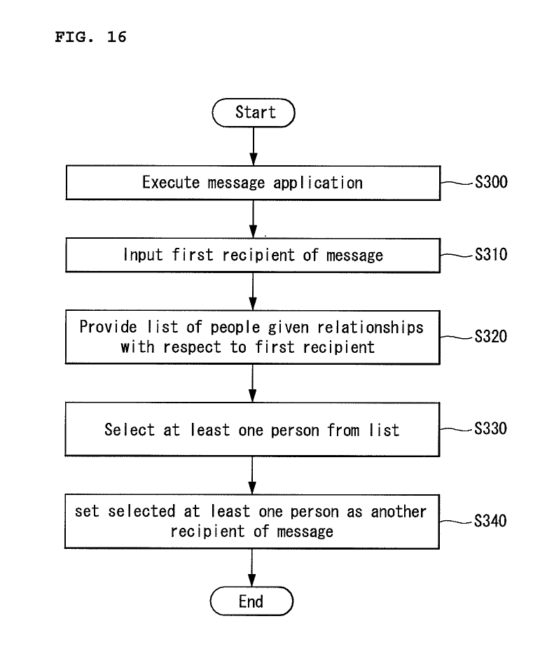

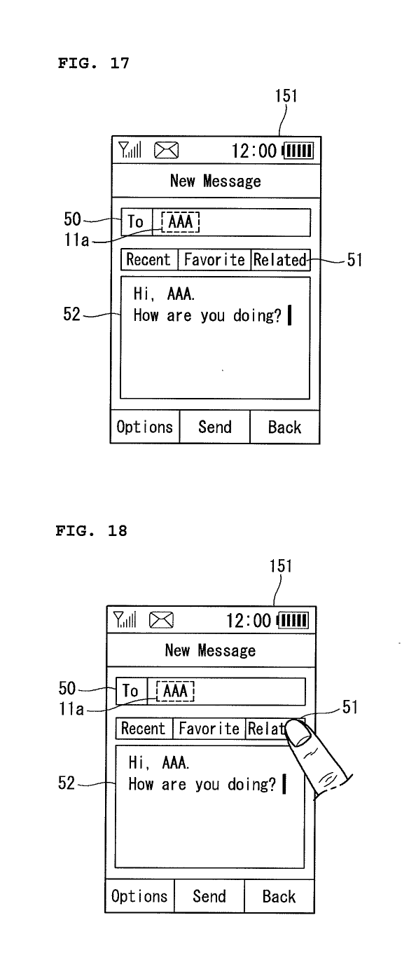

FIG. 16 is a flow chart illustrating a second exemplary embodiment of the process of providing data. FIGS. 17 to 21 are views for explaining an actually implemented example of providing data according to the second exemplary embodiment. FIGS. 17 to 21 show examples in which when a specific person is selected as a recipient of a message in a message application, information regarding other people related to the selected person is provided. The second embodiment related to data provision will now be described in detail with reference to FIGS. 16 to 21.

Here, as described above, the message may include at least one of the SMS, MMS, e-mail, and IM.

The controller 180 drives or executes the message application (S300) and receives a first recipient of the message from the user (S310).

For example, with reference to FIG. 17, the controller 180 may display a screen corresponding to the message application on the display unit 151.

As shown in FIG. 17, the message application may provide a recipient input window 50 and an input window 52 for receiving message content.

A first recipient illustrated in FIG. 17 is the first person 11a.

The controller 180 may provide a list of other people assigned the relationship with respect to the first recipient (S320).

For example, as shown in FIG. 18, the controller 180 may receive a selection signal with respect to an icon 551 to which the list providing function is matched. As the icon 51 is selected, as shown in FIG. 19, the controller 180 may provide a list of other people assigned the relationship with respect to the first recipient as a pop-up window 55.

When the relationships between or among the plurality of people illustrated in FIG. 10 are assumed, the pop-up window 55 may include a list of the second to fourth people 11b, 11c, and 11d.

The pop-up window 55 may include icons 56 for adding at least one of the list of other people as another recipient of the message.

The controller 180 may receive a selection signal with respect to at least one other person on the provided list (S330).

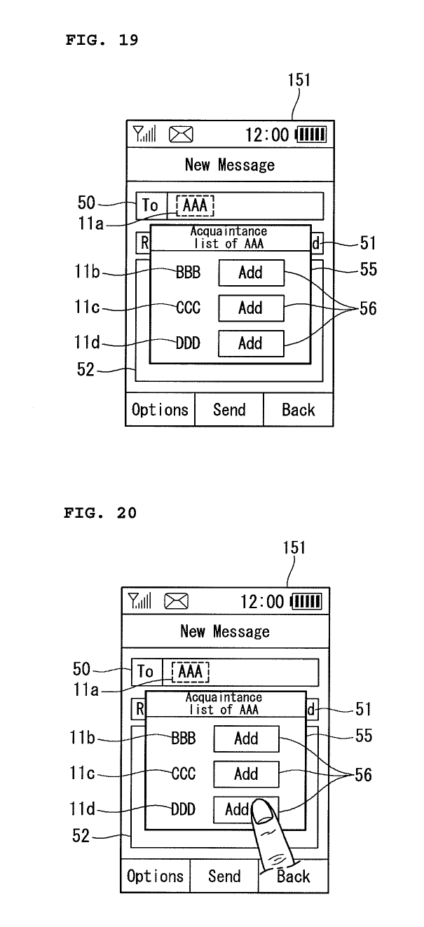

For example, with reference to FIG. 20, the user may select the icon 56 in order to add the fourth person 11d on the list of other people included in the pop-up window 55 as a recipient of the message.

The controller 180 may set at least one other person selected in step S330 as another recipient besides the first recipient (S340).

For example, with reference to FIG. 21, as the fourth person 11d is selected in FIG. 20, the controller 180 sets the fourth person 11d as an additional recipient and displays the fact that the first person 11a and the fourth person 11d are currently set as the recipients of the message through the recipient input window 50.

As a third embodiment of the data provision, the controller 180 may provide information related to a message transmitted to and/or received from at least one person assigned the relationship according to the present exemplary embodiments with respect to a specific person that has transmitted and received a message.

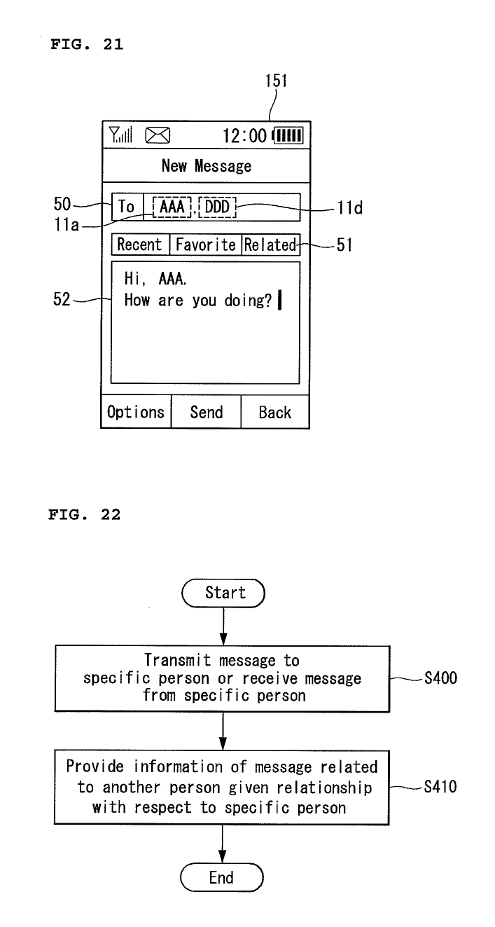

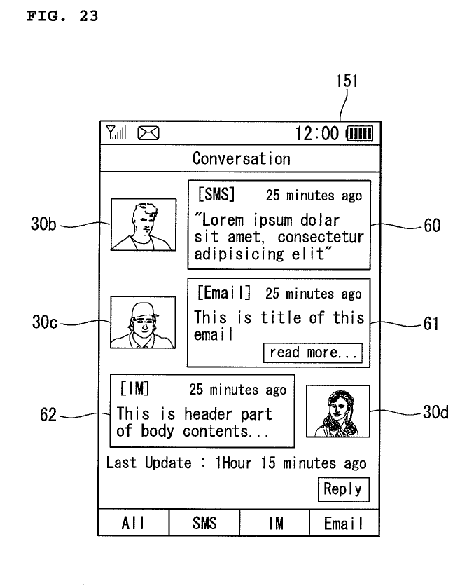

FIG. 22 is a flow chart illustrating a third exemplary embodiment of the process of providing data. FIG. 23 is a view for explaining an actually implemented example of providing data according to the third exemplary embodiment of the present invention. The third exemplary embodiment related to the data provision will now be described in detail.

The controller 180 transmits message to a specific person and/or receives message from a specific person (S400). For example, the user of the electronic device 100 may transmit message to the first person 11a and/or receive a message from the first person 11a. Here, as described above, the message may include at least one of the SMS, MMS, e-mail, and IM. Hereinafter, it is assumed that the user of the electronic device 100 transmits message to the first person 11a and/or receives a message from the first person 11a.

The controller 180 searches for another person assigned or acquired a relationship according to the present exemplary embodiments with respect to the specific person which the message has been transmitted to and/or received from, and provide information of the message related to the searched another person (S410).

Step S410 may be performed according to a user request or when a predetermined reference is satisfied. For example, step S410 may be set to be performed when there is no more message transmission and reception for a certain period of time in a state that transmission and reception of a message to and from the specific person is completed.

Also, for example, an icon corresponding to the performing of step S410 may be provided, and when the user selects the provided icon, the controller 180 may perform step S410.

For example, with reference to FIG. 23, the controller 180 may provide a list of messages transmitted and received to and from the second to fourth people 11b, 11c, and 11d assigned the relationship with respect to the first person 11a and their brief information on the display unit 151.

The screen image illustrated in FIG. 23 briefly displays the representative images 30b, 30c, and 30d representing the second to fourth people 11b, 11c, and 11d, and types (e.g., SMS, Email, IM) and content 60, 61, and 62 of the messages exchanged with the second to fourth people 11b, 11c, and 11d, and time information at which the messages were transmitted and received.

Through the screen image illustrated in FIG. 23, the user may be provided with information regarding the messages transmitted to and/or received from the other people who have a high affinity with the first person 11a or who have been assigned the relationship.

When the user selects a specific message (e.g., 60), the controller 180 may change the screen image into an image displaying detailed information of the selected message.

The method for providing information of the electronic device according to exemplary embodiments of the present invention may be recorded in a computer-readable recording medium as a program to be executed in the computer and provided.

The method for providing information of the electronic device according to exemplary embodiments of the present invention may be executed by software. When executed by software, the elements of the exemplary embodiments of the present invention are code segments executing a required operation. The program or the code segments may be stored in a processor-readable medium or may be transmitted by a data signal coupled with a carrier in a transmission medium or a communication network.

The computer-readable recording medium includes any kind of recording device storing data that can be read by a computer system. The computer-readable recording device includes a ROM, a RAM, a CD-ROM, a DVD±ROM, a DVD-RAM, a magnetic tape, a floppy disk, a hard disk, an optical data storage device, and the like. Also, codes which are distributed in computer devices connected by a network and can be read by a computer in a distributed manner are stored and executed in the computer-readable recording medium.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. An electronic device, comprising:
a memory configured to store a database configured to manage information regarding a plurality of people; and
a controller operatively connected to the memory and configured to
assign relationships between or among the plurality of people according to a first reference, and
manage data related to the plurality of people according to the assigned relationships.

2. The device of claim 1, wherein the controller is configured to assign the relationships to at least two or more people, the two or more people managed as a same group in the electronic device, the same group being the first reference.

3. The device of claim 2, wherein the controller is configured to recognize that the at least two or more people belong to the same group based on one of
entries in a phone book stored in the electronic device, and
a joint mention of the at least two or more people in specific data stored in the electronic device.

4. The device of claim 1, wherein the controller is configured to assign the relationships to at least two or more people when the at least two or more people are jointly included in a message transmitted or received by the electronic device, as the first reference, the message being at least one of a short message service (SMS), a multimedia messaging service (MMS), an e-mail, and an instant message (IM).

5. The device of claim 4, wherein the at least two or more people are joint recipients of the message or wherein the at least two or more people corresponds to one of a recipient, a sender, and a person mentioned in the message.

6. The device of claim 1, wherein the controller is configured to
receive information regarding the relationships from an external terminal providing a social network service (SNS), as the first reference, and
assign the relationships based on the received information.

7. The device of claim 1, wherein the controller is configured to update the relationships when an event corresponding to the first reference occurs.

8. The device of claim 1, wherein the controller is configured to assign levels to the relationships according to a second reference different from the first reference.

9. The device of claim 8, wherein the controller is configured to manage the data related to the plurality of people according to the assigned levels of the relationships.

10. The device of claim 1, wherein the controller is configured to provide data related to a second person selected from the plurality of people with respect to a first person selected from the plurality of people, the second person being different from the first person.

11. The device of claim 10, wherein the data related to the second person is information representing the second person.

12. The device of claim 11, wherein the controller is configured to display the information representing the second person in a list.

13. The device of claim 10, wherein the data related to the second person comprises a message, a schedule, and phone book information related to the second person, the message being one of a short message service (SMS), a multimedia messaging service (MMS), an e-mail, and an instant message (IM).

14. A method for providing information of an electronic device including database managing information regarding a plurality of people, the method comprising:
assigning relationships between or among the plurality of people according to a first reference; and
managing data related to the plurality of people according to the assigned relationships.

15. The method of claim 14, wherein the assigning of the relationships comprises at least one of:
assigning the relationships between or among at least two or more people managed in the electronic device as a same group;
assigning the relationships between or among at least two or more people jointly included in a message transmitted or received by the electronic device; and
receiving information regarding the relationships between or among the plurality of people from an external terminal providing a social network service (SNS), and assigning the relationships on the basis of the received information.

16. The method of claim 15, wherein the message comprises a message transmitted or received through at least one of a short message service (SMS), a multimedia messaging service (MMS), an e-mail, and an instant message (IM).

17. The method of claim 15, further comprising:
assigning levels to the assigned relationships according to a second reference.

18. The method of claim 17, further comprising:
updating the assigned relationships or the levels when an event corresponding to the at least one first reference occurs.

19. The method of claim 17, wherein the step of managing of the data related to the plurality of people comprises:
providing data related to a second person from the plurality of people with respect to a first person selected from the plurality of people, the second person being different from the first person.

20. The method of claim 19, wherein the data related to second person comprises at least one of information, a message, a schedule, phone book information representing the second person.
